(19) United States
(12) Patent Application Publication
(10) Pub. No.: US 2008/0206006 A1
(43) Pub. Date: Aug. 28, 2008

(54) Interchangeable Rotary Tool Bit for a Handheld Power Drill

(76) Inventor: Ulrich Bohne, Kohlberg (DE)

Correspondence Address: MICHAEL J. STRIKER, 103 EAST NECK ROAD, HUNTINGTON, NY, 11743, US

(21) Appl. No.: 11/916,555

(22) PCT Filed: Feb. 12, 2007
(86) PCT No.: PCT/EP2007/051331

§ 371 Date: Dec. 5, 2007

(30) Foreign Application Priority Data
Apr. 10, 2006 (DE) 10 2006 016 805.4

(51) Int. Cl. B23B 51/00; B21K 5/00

(52) U.S. Cl. 408/226; 76/115

(57) ABSTRACT

The invention relates to an exchangeable rotary tool for a hand-held machine tool with a drill and/or hammer function, especially for a hammer drill. Said rotary tool comprises an insertable shank to be accommodated in a tool holder of the hand-held machine tool, said shank having at least two driving fins extending along its longitudinal extent for rotational engagement. The driving fins (7), when seen in the cross-section, are diametrically opposite on the insertable shank (2) and at least one of the driving fins (7) has an axial interruption (10) for the purpose of axial locking. The invention also relates to a corresponding method of production.

The invention relates to an interchangeable rotary tool bit for a handheld power tool having a drilling and/or hammering function, in particular for a drill hammer, having an insert shaft for reception in a tool bit mount of the handheld power tool, which shaft has at least two slaving ribs, extending longitudinally of it, for rotary slaving.

### PRIOR ART

A rotary tool bit of the type defined above is known. In a handheld power tool with a drilling and/or hammering function, a tool bit mount of the handheld power tool receives an insert shaft of the rotary tool bit and drives the rotary tool bit—such as a drill—to rotate via slaving ribs and/or slaving grooves that extend longitudinally of the insert shaft. Alternatively or simultaneously, a percussion mechanism of the power tool periodically causes the rotary tool bit to execute repeated blows. Unlike power drills or percussion power drills, where the insert shaft of the rotary tool bit employed is firmly clamped in a multi-part chuck (such as a 3-jaw drill chuck) of the tool bit mount, drill hammers in particular have a tool bit mount with a rotationally drivable receiving bush, which has a recess, open on both face ends, for receiving the insert shaft of the rotary tool bit employed. For axially locking the insert shaft in the receiving bush, also called a hammer barrel, a locking ball is conventionally provided, which by means of a spring-loaded locking ring surrounding the receiving bush is brought into engagement behind an undercut of the rotary tool bit. For rotary slaving, the insert shaft of the rotary tool bit has a noncylindrical cross section, for instance in what is called an “SDS-plus” profile, two diametrically opposed slaving grooves, which extend longitudinally of the insert shaft and are open toward its rear face end; upon insertion of the tool bit into the recess, complementary slaving ribs on the inner circumferential surface of the receiving bush mesh with these slaving grooves. However, this kind of slaving system is relatively complex to produce, since corresponding grooves in the insert shaft have to be made by metal-cutting machining processes, and thus are suitable only for an insert shaft with a relatively large diameter.

### ADVANTAGES OF THE INVENTION

The rotary tool bit of the invention has the slaving ribs diametrically opposite one another on the insert shaft—viewed in cross section—and at least one of the slaving ribs has an axial interruption for axial locking. Slaving ribs embodied in this way have two different functions: First, the slaving ribs serve to transmit a torque from the tool bit mount of the handheld power tool to the rotary tool bit; second, the slaving rib with the axial interruption additionally serves the purpose of axial locking. By means of slaving ribs located diametrically opposite one another on the insert shaft—as viewed in cross section—good concentricity properties with high torque transmission are provided for. As the rotary tool bits, rock and wood drills, for instance, as well as screwdriver bits with a corresponding embodiment of the insert shaft are contemplated. Because of the “inverse” location of the slaving strips on the insert shaft, compared to the SDS-plus profile, or of slaving grooves engaging the slaving ribs in the tool receptacle, wear of the tool receptacle is shifted to the rotary tool bit, so that the service life of the tool receptacle and hence of the entire handheld power tool is increased. In contrast to slaving grooves of a conventional insert shaft, which are produced with metal-cutting production methods, the slaving strips of the insert shaft can be integrally formed in an arbitrary way. This makes less-expensive production of the rotary tool bits possible.

Preferably, the insert shaft has only two slaving ribs. An insert shaft with two slaving ribs located diametrically opposite one another—as viewed in cross section—is simple to produce and has good concentricity properties. Both slaving ribs can in particular each have an axial interruption, and the axial interruptions are embodied identically. If each of the slaving ribs has an axial interruption for axial locking, then the rotary tool bit can be inserted into the tool bit receptacle and locked correspondingly in two orientations rotated 180° from one another.

It is also advantageous if the insert shaft has one, or essentially one, circular cross section. An insert shaft of a rotary tool bit with a circular cross section can be easily centered and is also suitable for tool bit mounts of small dimensions.

In a preferred embodiment, it is provided that the slaving ribs have longitudinal sides which form plane slaving flanks. Slaving ribs with plane slaving flanks are distinguished by good torque transmission and can be produced simply and economically.

In a refinement of the invention, it is provided that the longitudinal sides of each slaving rib extend parallel to one another. Slaving ribs with longitudinal sides located in this way can be produced by economical production methods, such as “squishing” of the slaving ribs. If there are only two slaving ribs, this can be done in only a single work step.

In a preferred embodiment, it is provided that the slaving flanks extend radially or approximately radially to the pivot axis of the rotary tool bit. Radially located slaving flanks, together with suitably located slaving flanks of the tool bit mount, assure high torque transmission. Especially with parallel-oriented longitudinal sides of each slaving rib, the slaving flanks extend approximately radially to the pivot axis of the rotary tool bit, in order to enable a parallel orientation of the longitudinal sides.

It is also advantageous if the insert shaft with the slaving ribs has a circumferential contour corresponding to a Torx profile. In rotary tool bits, Torx profiles are widely used, so that a combination of the rotary tool bit with other power tools is possible. An insert shaft with six slaving ribs, which has a circumferential contour corresponding to a Torx profile, can also be clamped into a conventional 3-jaw drill chuck of a power drill or percussion power drill.

It may also be advantageous if the diameter of the insert shaft in the region of the axial interruption is the same size as in its slaving-rib-free region.

In a refinement of the invention, it is provided that the insert shaft has a cross section which over its longitudinal extent has a cross-sectional area that remains constant or virtually constant. In the hammering mode, or in a combined drilling and hammering mode, a beater or percussion bolt axially strikes an end face of the insert shaft. The result is a shockwave, passing through the rotary tool bit longitudinally, that is partly reflected in portions of the insert shaft that have a varying cross-sectional area. By superimposing such outgoing and returning shockwaves, locally excessive stresses can occur in the rotary tool bit, which can lead to breakage of the tool bit. If the cross-sectional area of the insert shaft remains constant or nearly constant, such reflections are suppressed, so that the shockwave, in operation without reflection, is transmitted to a workpiece located in front of the rotary tool bit.

It is also advantageous if the diameter of the insert shaft is between 4 mm (millimeters) and 8 mm, preferably between 6.5 mm and 7.0 mm. By means of such a slight diameter of the insert shaft, a cost reduction in production is achieved from a reduced use of material.

It is also advantageous if the slaving rib with the axial interruption is divided by the axial interruption into a first and a second axial rib portion, and the first axial rib portion—viewed from a rotary tool bit machining region adjoining the insert shaft—is located in front of the axial interruption, and the second axial rib portion is located behind the axial interruption, and the first axial rib portion is longer than the second axial rib portion. With this kind of division, the locking of the rotary tool bit is on the side of the insert shaft remote from the machining region, while the rotary slaving is assured via an elongated portion along an extended portion of the insert shaft.

The invention also relates to a method for producing an insert shaft of a rotary tool bit having at least two slaving ribs for rotary slaving, extending along its longitudinal extent. It is provided that—beginning at a circular cross section of the insert shaft—the insert shaft is upset in at least two circumferential regions of at least one axial portion, so that between the circumferential regions subjected to pressure, material emerges radially, and protruding slaving ribs are created which are located diametrically opposite one another, and at least one of the slaving ribs has an axial interruption. This kind of production method is also known as “squishing” of the slaving ribs. If only two slaving ribs are squished, this can be done in only a single work step.

Finally, every handheld power tool having a drilling and/or hammering function, in particular a drill hammer, having a tool bit mount and an interchangeable rotary tool bit comes within the scope of protection of the associated claims. The tool bit mount in particular has a receiving bush with a recess for receiving the insert shaft, and the recess is open on both ends and between them is bounded by an inner circumferential face. The inner circumferential face has at least two slaving grooves, extending longitudinally of the receiving bush, for torque transmission, and at least one of the slaving grooves has a locking ball for axial locking. A tool bit receptacle of this kind is distinguished by high-precision concentricity, since the cylindrical recess can be produced precisely, and only the slaving grooves have to be reamed or punched.

### DRAWINGS

The invention is described in further detail below in three exemplary embodiments in conjunction with the drawings. Shown are:

FIGS. 1a and 1b, a longitudinal side view and a perspective view, respectively, of an insert shaft with two slaving ribs that are integrally formed by squishing;

FIG. 2, a perspective view of an insert shaft with slaving ribs that are integrally formed arbitrarily;

FIG. 3, an end-on view of an insert shaft, in which the upper slaving rib is integrally formed by squishing and the lower slaving rib is integrally formed arbitrarily;

FIGS. 4a and 4b, a longitudinal side view and an end view of an insert shaft with a Torx profile;

FIG. 4c, a receiving bush with an internal Torx profile and a locking ball;

FIG. 5a, a longitudinal section through a tool bit mount of a handheld power tool after the insertion of the rotary tool bit of FIG. 1 or FIG. 2; and

FIG. 5b, a perspective view of a tool bit mount of the handheld power tool.

### DESCRIPTION OF THE EXEMPLARY EMBODIMENTS

The handheld power tool with a drilling and/or hammering function, shown only in part, can be equipped with rotary tool bits 1 that can have variously embodied insert shafts 2.

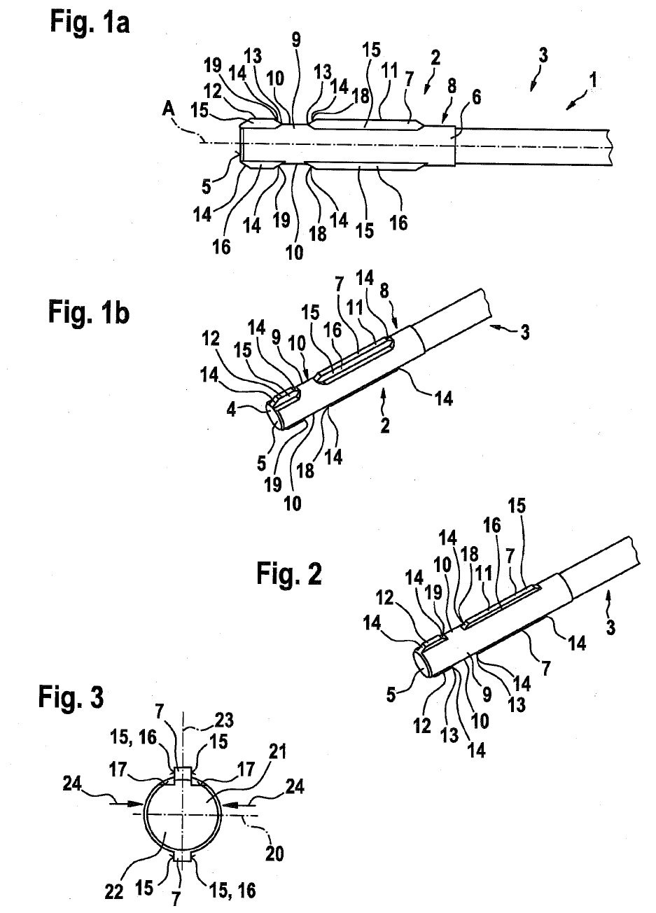

FIGS. 1a and 1b show the insert shaft 2 and a beginning portion of a machining region 3 not shown. The insert shaft 2 has an essentially circular cross section 4, which can be seen clearly at the end face 5 in FIG. 1b. An end 6 of the insert shaft 2, diametrically opposite the end face 5, is adjoined by the machining region 3 of the rotary tool bit 1. Beginning at the end face 5, two slaving ribs 7 extend along the longitudinal extend (axis A) of the insert shaft 2 until shortly before the end 6, and this end itself is embodied as a slaving-rib-free region 8. In an axial intermediate portion 9 of the insert shaft 2, the slaving ribs 7 each have one axial interruption 10, and each of the slaving ribs 7 is divided by the axial interruption 10 into a first axial rib portion 11 and a second axial rib portion 12. The first axial rib portion 11, viewed from the machining region 3, is located in front of the axial interruption 10, and the second axial rib portion 12 is located behind the interruption, and the first axial rib portion 11 is longer than the second axial rib portion 12. Both axial rib portions 11, 12 of each slaving rib 7, on their ends 13 diametrically opposite one another longitudinally, have beveled end regions 14. The end regions 14, toward the axial interruption 10, of the axial rib portions 11, 12 form two shoulders 18, 19 of the axial interruption 10. The front shoulder 18 is on the first axial portion 11, and the rear shoulder 19 is on the second axial portion 12. The slaving ribs 7 have longitudinal sides 15, extending parallel to one another, that form plane slaving flanks 16. The essentially circular cross section 4 of the insert shaft 2 is indented (flattened) in axial regions 17 of the axial rib portions 11, 12 perpendicularly to the longitudinal sides 15, and the cross-sectional area is thus reduced. This kind of deformation occurs for instance when the slaving ribs 7 are formed integrally onto the insert shaft 2 by squishing.

FIG. 2 shows the insert shaft 2 of a rotary tool bit 1 that corresponds essentially to that of FIG. 1b; the indented regions 17 on the axial rib portions 11, 12 are missing, so that the insert shaft 2 has a circular cross section 4.

FIG. 3 clearly shows the difference between the two embodiments of the insert shaft 2: The end view, divided by the axis 20 into an upper region 21 and a lower region 22, combines the two exemplary embodiments in a single illustration. The upper region 21 of FIG. 3 shows the embodiment of the insert shaft 2 with indented regions 17, while the lower region 22 shows the embodiment without the indented regions 17. The longitudinal sides 15, serving as slaving flanks 16, of the slaving ribs 7 are embodied as markedly larger in the region 21, because of the indented regions 17, than the longitudinal sides 15 in the region 22. The slaving ribs 7 on the insert shaft 2 are diametrically opposite one another on the axis 23 and have longitudinal sides 15 that are embodied parallel to this axis of symmetry 23. When the slaving ribs 7 are squished, the insert shaft 2—beginning from a circular cross section—is upset in at least two circumferential regions of at least one axial portion (arrows 24) that between the circumferential regions subjected to pressure, material emerges radially and creates the slaving ribs 7.

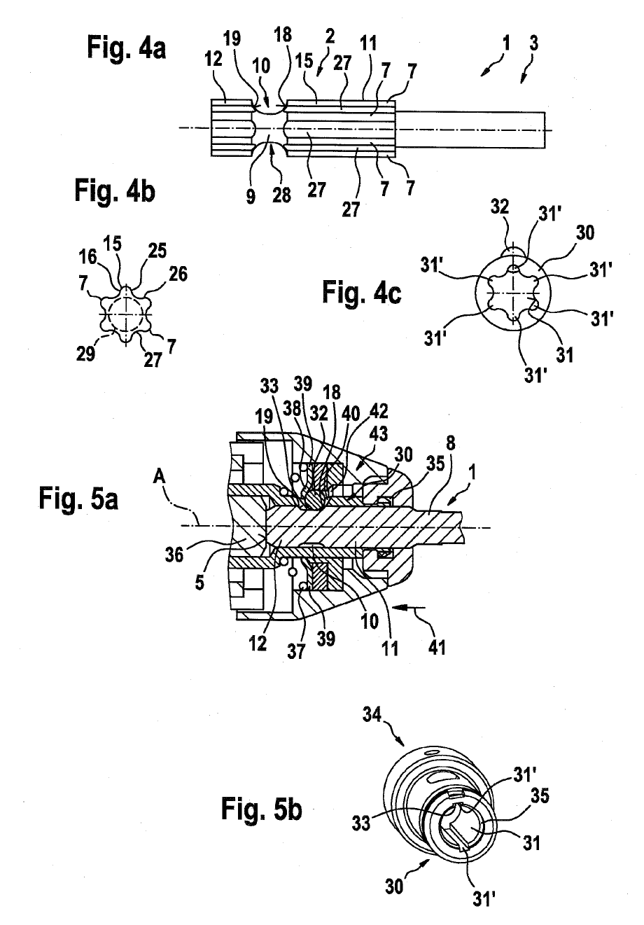

FIGS. 4a and 4b show the insert shaft 2 of a rotary tool bit 1 in which the insert shaft 2 with the slaving ribs 7 has a circumferential contour 25 corresponding to a Torx profile 26. FIG. 4a shows a side view, which is essentially equivalent to FIG. 1a; in FIG. 4a, the insert shaft 2 has six slaving ribs 7, each two of which, diametrically opposite one another, are offset radially by 60° from one another. The longitudinal sides 15 of the slaving ribs 7 merge in curved fashion with slaving-rib-free circumferential regions 27 of the insert shaft 2, creating the Torx profile 26. The axial interruption 10, which divides each of the slaving ribs 7 into a first axial rib portion 11 and a second axial rib portion 12, is embodied as an annular groove 28, whose cross section 29 is smaller than the cross section 4 of the insert shaft 2.

FIG. 4c shows a receiving bush 30, which has an inner circumferential face 31 with a Torx profile 25 that corresponds to that of the insert shaft 2 of FIGS. 4a and 4b. In the vicinity of a slaving groove 31′ that receives a slaving rib 7, there is a locking ball 32, which when an insert shaft 2 of a rotary tool bit has been inserted engages the axial interruption 10 of one of the slaving ribs 7 and axially locks the rotary tool bit 1.

FIG. 5a shows the tool bit mount 34 with the receiving bush 30, this bush being open on the face end 35 and being driven to rotate about its longitudinal axis by a rotary drive means, not shown. The receiving bush 30 has a recess 33 on its upper side, by means of which recess the locking ball 32 can be made to engage the axial interruption 10 of the insert shaft 2, inserted into the receiving bush 30, of the rotary tool bit 1 for the sake of axially locking the rotary tool bit 1. The position of the axial interruption 10 is selected such that the locking ball 32 is located immediately in front of a front shoulder 18 of the first axial rib portion 11 when the insert shaft 2 strikes a percussion bolt 36 of the power tool, so that the rotary tool bit 1 is firmly held in the receiving bush 30 with sufficient axial play. Thus after the insertion of the rotary tool bit 1, the locking ball 32 is located in the vicinity of a front shoulder 18 of the first axial rib 11. If the percussion bolt 36 strikes the end face 5 of the insert shaft 2, then by the time the rear shoulder 19 of the second axial rib portion 12 is reached, there is sufficient axial play for unhindered percussion transmission in percussion drilling. The locking ball 32 is pressed by a conical spring 37, via a flexible metal sheet 39 that embodies a shoulder 38, in the direction of a front edge 40 of the recess 33 in the locked state (FIG. 5a), so that it is fixed in the axial interruption 10 of the insert shaft. For unlocking, the user presses a locking bush 43, counter to the force of the conical spring 37, in the direction of the handheld power tool (arrow 41), so that the locking ball 32 can shift radially outward into a region 42 and releases the insert shaft 2.

FIG. 5b shows the tool bit mount 34 with the receiving bush 30, which has an inner circumferential face 31 with at least two slaving grooves 31′ extending longitudinally of the receiving bush 30; in the region of at least one of the slaving grooves 31′, the receiving bush has a recess 33 for receiving the locking ball 32.

1. An interchangeable rotary tool bit for a handheld power tool having a drilling and/or hammering function, in particular for a drill hammer, having an insert shaft for reception in a tool bit mount of the handheld power tool, which shaft has at least two slaving ribs, extending longitudinally of it, for rotary slaving, characterized in that—viewed in cross section—the slaving ribs (7) are located diametrically opposite one another on the insert shaft (2); and that at least one of the slaving ribs (7) has an axial interruption (10) for axial locking.

2. The rotary tool bit as defined by claim 1, characterized in that the insert shaft (2) has only two slaving ribs (7).

3. The rotary tool bit as defined by claim 1, characterized in that the insert shaft (2) has one, or essentially one, circular cross section (4).

4. The rotary tool bit as defined by claim 1, characterized in that the slaving ribs (7) have longitudinal sides (15) which form plane slaving flanks (16).

5. The rotary tool bit as defined by claim 1, characterized in that the longitudinal sides (15) of each slaving rib (7) extend parallel to one another.

6. The rotary tool bit as defined by claim 1, characterized in that the slaving flanks (16) extend radially or approximately radially to the pivot axis (A) of the rotary tool bit (1).

7. The rotary tool bit as defined by claim 1, characterized in that the insert shaft (2) with the slaving ribs (7) has a circumferential contour (25) corresponding to a Torx profile (26).

8. The rotary tool bit as defined by claim 1, characterized in that the diameter of the insert shaft (2) in the region of the axial interruption (10) is the same size as in its slaving-rib-free region (8).

9. The rotary tool bit as defined by claim 1, characterized in that the insert shaft (2) has a cross section (4) which over its longitudinal extent has a cross-sectional area that remains constant or virtually constant.

10. The rotary tool bit as defined by claim 1, characterized in that the diameter of the insert shaft (2) is between 4 mm and 8 mm, preferably between 6.5 mm and 7.0 mm.

11. The rotary tool bit as defined by claim 1, characterized in that the axial interruption (10) divides the slaving rib (7) into a first and a second axial rib portion (11, 12), and the first axial rib portion (11)—viewed from a machining region (3) of the rotary tool bit (1) adjoining the insert shaft (2)—is located in front of the axial interruption (10), and the second axial rib portion (12) is located behind the axial interruption (10), and the first axial rib portion (11) is longer than the second axial rib portion (12).

12. A method for producing an insert shaft of a rotary tool bit having at least two slaving ribs for rotary slaving, extending longitudinally, characterized in that—beginning at a circular cross section of the insert shaft—this shaft is upset in at least two circumferential regions of at least one axial portion, so that between the circumferential regions subjected to pressure, material emerges radially, and protruding slaving ribs are created which are located diametrically opposite one another, and at least one of the slaving ribs has an axial interruption.

13. A handheld power tool having a drilling and/or hammering function, in particular a drill hammer, having a tool bit mount and an interchangeable rotary tool bit as defined by claim 1.
